(19) United States
(12) Patent Application Publication
(10) Pub. No.: US 2013/0217558 A1
(43) Pub. Date: Aug. 22, 2013

(54) METHOD AND DEVICE FOR PRODUCING A SEMI-FINISHED WEB AND METHOD FOR PRODUCING A COMPOSITE MATERIAL

(71) Applicants: René GLÖCKNER, Eppendorf (DE); Lutz PANDER, Chemnitz (DE)

(72) Inventors: René GLÖCKNER, Eppendorf (DE); Lutz PANDER, Chemnitz (DE)

(73) Assignee: KARL MAYER MALIMO TEXTILMASCHINENFABRIK GMBH, Chemnitz (DE)

(21) Appl. No.: 13/492,206

(22) Filed: Jun. 8, 2012

(30) Foreign Application Priority Data
Feb. 22, 2012 (EP) 12001160.6

(51) Int. Cl. B31B 1/00

(52) U.S. Cl. 493/393

(57) ABSTRACT

Method and device for producing a semi-finished web having a longitudinal direction, a plastic matrix, and a plurality of fibers fixed in a unidirectionally oriented manner enclosing a predetermined angle (a) greater than 0° to the longitudinal direction. The method includes supplying a web having a main direction, a plastic matrix, and a plurality of fibers fixed in a unidirectionally oriented manner enclosing an angle of about 0° to the main direction, separating segments from the supplied web, arranging the separated segments next to one another so that longitudinal edges of adjacent segments are parallel to the main direction and to one another, and enclose the predetermined angle (a) to the longitudinal direction, and connecting the adjacent segments in a region of their longitudinal edges.

### CROSS-REFERENCE TO RELATED APPLICATIONS

The present application claims priority under 35 U.S.C. §119 of European Patent Application No. 12 001 160.6, filed on Feb. 22, 2012, the disclosure of which is expressly incorporated by reference herein in its entirety

### BACKGROUND OF THE INVENTION

1. Field of the Invention

The invention relates to a method and a device for producing a semi-finished web.

2. Discussion of Background Information

Components of fiber-reinforced plastic are used in many fields of technology. Components of fiber-reinforced plastic have the advantage over metal components of higher specific mechanical properties. Furthermore, plastics can also be used in areas where metals would corrode.

EP 2 301 735 A2 (and its counterpart U.S. Patent Publication No. US 2011/0076441), the disclosures of which are expressly incorporated by reference herein in their entireties, shows a semi-finished product and a semi-finished product composite as well as production methods for this semi-finished product. Unidirectionally oriented fibers are arranged between two layers of thermoplastic material. This composite then forms a type of “metal sheet” that can be shaped in a similar manner to a metal sheet. This semi-finished product has a relatively high tensile strength in the direction in which the fibers extend. The tensile strength is much lower in a direction transverse to the longitudinal extension of the fibers. In order to increase the tensile strength, several semi-finished products of this type are arranged one above the other, wherein the angular positions of the fibers differ from one another.

Another way of producing a semi-finished product with an increased tensile strength in several directions lies in the production of a so-called “multi-axial scrim.” Here several thread sheets are used, which are placed one on top of the other. The threads are arranged in a unidirectional manner in each thread sheet. The directions of the threads then differ among the thread sheets.

In both cases the production of a composite material or of a multiaxial scrim requires a substantial expenditure. When the threads or fibers are to have different directions, the thread sheets or semi-finished products must also be fed from different directions. This requires a relatively large installation space and as a rule also a relatively complicated control, because the individual feeder rolls have to be coordinated with one another.

### SUMMARY OF THE INVENTION

Embodiments of invention facilitate the production of multiaxially reinforced materials.

Accordingly, a method for producing a semi-finished web, which has a longitudinal direction, is provided, in which a plurality of fibers fixed in a unidirectionally oriented manner to enclose a predetermined angle greater than 0° to the longitudinal direction are in a plastic matrix. The method includes: the use of a supply web that has a main direction, a plastic matrix, and a plurality of fibers fixed with respect to one another in a unidirectionally oriented manner that enclose an angle equal to 0° to the main direction, the separation of segments from the supply web, the arrangement of the separated segments next to one another so that their longitudinal edges running parallel to the main direction are parallel to one another and adjacent and enclose the predetermined angle to the longitudinal direction, and the connection of the adjacent segments in the region of their longitudinal edges.

In this case, a semi-finished product can be used as a supply web, for example, as is known from EP 2 301 735 A2 and its counterpart US 2011/0076441. A semi-finished product of this type can be produced relatively easily because the two layers of plastic as well as the fibers or threads can be guided from the same direction and the stack formed thereby can be drawn off in the same direction. The terms “threads” and “fibers” are to be used in the same manner here. Of course, other semi-finished products can also be used, which are embodied or formed as fabric of fibers and plastics so that the fibers all have the same alignment. According to the invention, a semi-finished web in which the fibers enclose a predetermined angle that is greater than 0° to the longitudinal direction can now be produced in two simple steps from a supply web, in which the fibers run in the main direction, i.e., in the longitudinal direction of the supply web. To this end it is necessary merely to separate segments from the supply web and to arrange these segments then next to one another at the predetermined angle to the longitudinal direction and to connect them to one another. The separation of the segments from the supply web can take place in the running production process as well as also in an upstream step, such that the segments then can be kept in stock in a temporary storage unit. A semi-finished web is then obtained, in which the fibers are no longer oriented in the longitudinal direction, but at the predetermined angle to the longitudinal direction. Since this angle can also be embodied or formed differently with different semi-finished webs, the prerequisite for producing a multiaxially reinforced material has been established in a simple manner. To this end it is necessary merely to use at least two semi-finished webs with different fiber angles, i.e., the angles of the fibers to the longitudinal direction.

Advantageously, it is provided that the longitudinal edges of adjacent segments are laid edge to edge. A semi-finished web is then obtained that is relatively homogenous along its longitudinal direction. Defects on the longitudinal edges can be avoided.

Preferably, the segments are separated from the supply web at the predetermined angle. It is thereby possible to use the separation line on which the separation of the segments from the supply web takes place as the longitudinal edge of the semi-finished web. This saves material to a considerable extent, because waste can be avoided. The separation of the segments can be carried out with ultrasound, with a knife cut, for example, with a roll blade or a pinch-cutter, with scissors, with a band knife or with a guillotine or a falling knife.

Preferably, the supply web is fed at the predetermined angle to the longitudinal direction and the segments are separated parallel to the longitudinal direction. In this case the segments can be used without further change of direction and they can be arranged next to one another. This saves further handling steps.

Preferably, the segments are separated from the supply web with a length of their longitudinal edges that corresponds to the width of the semi-finished web divided by the cosine of the predetermined angle. The longitudinal edges are the edges that run parallel to the main direction of the supply web. By selection of a desired length, segments are obtained which, after joining, have exactly the width of the semi-finished web. A further processing, such as a cutting to produce the desired width, is no longer necessary.

Preferably, the segments are deposited on a transport device moveable in the longitudinal direction. In this case, the segments after being deposited can be moved further on the transport device so that sufficient space is available for depositing the next segment. The transport device can operate in a clocked manner, so that after the deposit of one segment, it is moved further by the width of the segment. However, it can also operate continuously. In this case it must be moved further by the width of a segment as long as the next segment is fed.

Alternatively or additionally to this, it can be provided that the segments are connected to one another to the semi-finished web and are transported further by a pull on the semi-finished web. The connection between adjacent segments does not even need to be completed before further transport. It can also be completed during or after the movement of the semi-finished web.

Preferably, the segments are connected to one another by adhesive force. Alternatively or additionally to this, it can advantageously be provided that adjacent segments are connected to one another by an adhesive strip that overlaps the adjacent longitudinal edges. A connection by adhesive force can be achieved, for example, by welding the segments on their longitudinal edges, i.e., on the abutting edges, by the application of heat. This welding can be carried out directly between adjacent segments if the segments have a weldable material, e.g., the plastic of their matrix. A strip of the material of the matrix of the segments that overlaps the two longitudinal edges can also be used, and the connection can be carried out with the aid of this strip, which can be welded to two adjacent segments. Heat sources such as laser, hot air or infrared radiation can be used for the heat supply. Another possibility for welding is the use of ultrasound. A further adhesive connection can be carried out by adhesives. These adhesives can be applied as adhesive spots or hot adhesive or adhesive strip. The adhesives can be applied to the abutting edges of the segments. However, it is also possible for the segments to overlap in the region of their longitudinal edges or an adhesive strip is used that overlaps both segments. The adhesive strip preferably is formed from the material of the matrix onto which adhesive is applied.

Preferably, the segments are subjected to a pressure treatment at least in the region of their connection to one another during and/or after the connection. This pressure treatment has two functions, i.e., to make the connection between adjacent segments firm and durable, and to equalize again a change in thickness in the region of the joint possibly caused by the connection. It can thus be ensured that the semi-finished web has a uniform thickness, which has a positive effect on the subsequent workability.

Preferably, a supply web with an edge strip is used. The edge strip of one segment overlaps an adjacent segment. The edge strip can be composed, for example, exclusively of matrix material, that is, it can be free from reinforcing fibers. For example, it can also have only one layer of a plastic material, if the fibers of the supply web are otherwise embedded between two layers of a plastic material. In this manner a very stable connection between two adjacent segments can be achieved.

Preferably, the semi-finished web is wound to form a lap roll and/or the supply web is unwound from a supply roll. The use of at least one roll facilitates handling.

Embodiments are directed to a device for producing a semi-finished web having a longitudinal direction and having a plastic matrix and a plurality of fibers fixed in a unidirectionally oriented manner, which enclose a predetermined angle greater than 0° to the longitudinal direction. The device includes: a dispensing arrangement for delivering segments, which has a main direction, a plastic matrix and a plurality of fibers fixed in a unidirectionally oriented manner, which enclose an angle equal to 0° to the main direction, an alignment device for arranging the segments next to one another so that their longitudinal edges running parallel to the main direction are parallel to one another and adjacent and enclose the predetermined angle to the longitudinal direction, and a connection device for connecting the adjacent segments in the region of their longitudinal edges.

The dispensing device can have, e.g., a roll of the supply web and a separating device. Several rolls of the supply web can also be arranged next to one another, such that all supply rolls can deliver respectively one segment at the same time. However, it can also have a storage unit in which segments that have previously been separated from the supply web are kept in stock. With a device of this type the method described above can be carried out in a simple manner.

Preferably, the alignment device has a transport device and the connection device can be moved in the longitudinal direction jointly with the transport device. A relatively long time is thus available for the connection between adjacent segments. The connection step can be carried out while the transport device moves the forming semi-finished web further by the width of one segment. When the connection device has several connection points, there is correspondingly more time available for the connection of adjacent segments.

Preferably, the connection device has a pressure device. The pressure device can be realized, e.g., by a pressure roll, by a nip between two compression rollers or by a clamping bar. The pressure device can press the segments flat together in the region of their joint, i.e., in the region of their longitudinal edges, so that the semi-finished web has a uniform thickness over its length and the connection is stable.

Embodiments of the instant invention are directed to a method for producing a semi-finished web having a longitudinal direction, a plastic matrix, and a plurality of fibers fixed in a unidirectionally oriented manner enclosing a predetermined angle (a) greater than 0° to the longitudinal direction. The method includes supplying a web having a main direction, a plastic matrix, and a plurality of fibers fixed in a unidirectionally oriented manner enclosing an angle of about 0° to the main direction, separating segments from the supplied web, arranging the separated segments next to one another so that longitudinal edges of adjacent segments are parallel to the main direction and to one another, and enclose the predetermined angle (a) to the longitudinal direction, and connecting the adjacent segments in a region of their longitudinal edges.

According to embodiments, the method can further include laying the longitudinal edges edge to edge.

In accordance with other embodiments, the segments can be separated from the supplied web at the predetermined angle (a). Further, the method can also include feeding the supplied web at the predetermined angle (a) to the longitudinal direction, and separating the segments along a line parallel to the longitudinal direction. The method can also include separating the segments from the supplied web so that a length of the longitudinal edges corresponds to a width (B) of the semi-finished web that is crosswise to the longitudinal direction divided by the cosine of the predetermined angle (a).

According to other embodiments, the method can include depositing the segments on a transport device moveable in the longitudinal direction.

The method can also include transporting the segments together by pulling the semi-finished web.

In accordance with still other features of the invention, the connecting of the segments may include connecting the segments to one another by adhesive force.

According to other features of the instant invention, the connecting of the segments can include connecting adjacent segments to one another by at least one of an adhesive strip and a strip of the material of the plastic matrix that overlaps the adjacent longitudinal edges.

Moreover, at least one of during and after connection, the method further includes subjecting the segments to a pressure treatment at least in the region of their connection to one another.

In accordance with other embodiments, the supplied web may have an edge strip, and the edge strip of one segment can overlap an adjacent longitudinal edge of an adjacent segment.

According to further embodiments, the method can also include at least one of: winding the semi-finished web form a lap roll; and unwinding the supplied web from a supply roll.

Embodiments of the invention are directed to a device for producing a semi-finished web having a longitudinal direction, a plastic matrix, and a plurality of fibers fixed in a unidirectionally oriented manner enclosing a predetermined angle (a) greater than 0° to the longitudinal direction. The device includes a dispensing arrangement for delivering segments having a main direction, a plastic matrix, and a plurality of fibers fixed in a unidirectionally oriented manner enclosing an angle of 0° to the main direction, an alignment device for arranging the segments next to one another so that longitudinal edges of the segments are parallel to the main direction and to one another, and enclose the predetermined angle (a) to the longitudinal direction, and a connection device for connecting the adjacent segments in the region of their longitudinal edges.

According to embodiments of the invention, the alignment device may include a transport device and the connection device can be structured and arranged to be jointly movable in the longitudinal direction with the transport device.

In accordance with other embodiments of the present invention, the connection device may include a pressure device.

The device may also include a separating device structured and arranged to separate the segments from a web supplied in the main direction. The separating device is positionable to separate the segment from the supplied web along a line in the longitudinal direction.

According to further embodiments, the device may also include a storage magazine into which a plurality of segments are storable and from which individual segments are movable in the main direction.

Embodiments of the invention are directed to a method for producing a semi-finished web having a plurality of fibers that are fixed in a plastic matrix and are unidirectionally oriented at an angle greater than 0° to a longitudinal direction of the semi-finished web. The method includes supplying in a main direction that is angularly offset from the longitudinal direction by more than 0° segments having a plurality of fibers that are fixed in a plastic matrix and are unidirectionally oriented generally parallel to the main direction, moving the supplied segments in the longitudinal direction so that successively supplied segments are arranged next to one another and so that longitudinal edges of adjacent segments are parallel to the main direction and to one another, and connecting the adjacent segments in a region of their longitudinal edges.

In accordance with still yet other embodiments of the present invention, the method can include one of: separating the segments from a supplied web along a line parallel to the longitudinal direction, the supplied web having a plurality of fibers that are fixed in a plastic matrix and are unidirectionally oriented generally parallel to the main direction, and storing a plurality of segments in a storage magazine and successively feeding the segments in the main direction.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

The FIGURE diagrammatically illustrates the production of a semi-finished web in accordance with embodiments of the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed in practice.

The FIGURE shows in an extremely diagrammatic form a semi-finished web 1 being formed with a longitudinal direction 2 represented by an arrow and including a plurality of fibers 3 fixed in a unidirectionally oriented manner. Fibers 3 are oriented or arranged to run at a predetermined angle a relative to longitudinal direction 2. Moreover, fibers 3 are embedded in a matrix of plastic, not shown in greater detail.

In order to produce semi-finished web 1, a supply web 4 is used. Supply web 4 can be unwound, e.g., from a supply roll 5. Optionally, several supply rolls 5 can also be arranged next to one another and correspondingly several supply webs 4 can be drawn off at the same time. Moreover, supply web 4 can also be produced online. Optionally, supply web 4 can be in the form of segments that can be stored and removed from a storage unit or magazine.

The web of a semi-finished product, which is described in EP 2 301 735 A2 and its counterpart U.S. Patent Publication No. US 2011/0076441, the disclosures of which are expressly incorporated by reference herein in their entireties, can be used as supply web 4. Supply web 4 can thus have a plurality of unidirectionally oriented fixed fibers 6 that are arranged between two layers of thermoplastic material. Other structures are also conceivable, of course, within the skill of the ordinarily skilled artisan. However, supply web 4 has a matrix of a plastic that holds fibers 6 in their unidirectionally oriented alignment.

Supply web 4 has a main direction 7 indicated by an arrow. In this regard, it is noted that, while main direction 7 is the “longitudinal direction” of supply web 4, the term “main direction” is used in this application for the purpose of differentiation and ease of explanation. Fibers 6 are aligned in the direction of main direction 7, i.e., they run parallel to the main direction 7. As used in this application, the term “parallel” is not being used in the strict mathematical sense, but is understood to mean that fibers 6 generally extend in the same direction as main direction 7.

As can be seen from the FIGURE, segments 8 are separated from supply web 4. Each segment has two longitudinal edges 9, 10, which are aligned parallel to main direction 7 and thus parallel to fibers 6. Longitudinal edges 9, 10 are likewise oriented at predetermined angle a relative to longitudinal direction 2.

A separating device 11 is used to separate segments 8 from supply web 4. Separating device 11 severs supply web 4, e.g., with the aid of ultrasound, with a knife, with scissors, with a band knife, with a falling knife or guillotine, or with some other suitable severing device. Separating device 11 thereby produces a separation line 12, which is oriented parallel to longitudinal direction 2, while supply web 4 is fed to separating device 11 at angle a relative to the longitudinal direction 2.

Separating device 11 separates segments 8 to have a width B of semi-finished web 1 so that a length of longitudinal edges 9, 10 of segment 8 corresponds to width B divided by the cosine of angle a. Thus, it is understood that longitudinal edges 9, 10 are longer than width B of semi-finished web 1. However, they are exactly so large that the segments 8 can later be assembled to form semi-finished web 1 with desired width B.

Since separation line 12 lies parallel to longitudinal direction 2, a change of direction of segments 8 before the joining to form semi-finished web 1 is no longer necessary.

Of course, segments 8 can also be removed from a magazine or a storage unit in which they have previously been deposited.

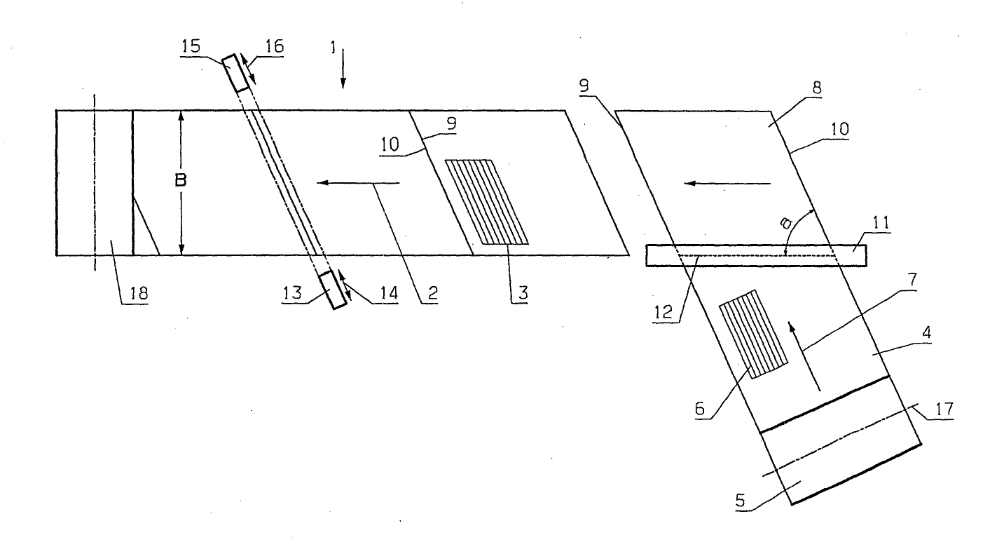

Segments 8 are deposited one after the other on a conveyor device, not shown in greater detail, and conveyed in longitudinal direction 2. As soon as sufficient space is available, the next segment 8 is deposited on the conveyor device. The representation in FIG. 1 shows a segment 8 separated from semi-finished web 1. This representation is intended to facilitate and simplify the explanation of the process. In fact, segment 8 is deposited following the already completed portion of semi-finished web 1.

If segments 8 are connected to one another immediately after being deposited, semi-finished web 1 may itself form the conveyor device, i.e., space for the next segment 8 is created by a pull on semi-finished web 1.

The connection of adjacent segments 8 on their longitudinal edges 9, 10 can be carried out in different ways. Longitudinal edges 9, 10 can be placed, e.g., edge to edge and welded to one another by the application of heat or ultrasound. A strip overlapping the longitudinal edges 9, 10 can also be used. In this regard, the strip can be formed of the same material as the matrix material of supply web 4, and this strip can then be welded or adhered to segments 8. Still further, an adhesive strip can also be used or longitudinal edges 9, 10 lying edge to edge can be adhered to one another directly. To this end, for example, a hot adhesive can be used. Adjacent segments 8 can also be allowed to overlap in the region of their longitudinal edges and then can be fused to one another. For heat supply, conventional sources such as laser, hot air or infrared radiation are possible.

A connection device 13 is shown diagrammatically, which can be guided over semi-finished web 1 in the direction of a double arrow 14, i.e., over the two adjacent longitudinal edges 9, 10 of adjacent segments 8. A pressure device 15 is likewise diagrammatically shown, which can be guided over semi-finished web 1 in the direction of a double arrow 16. Connection device 13 and pressure device 15 can act separately from one another or jointly. In the latter case, they can also be embodied or formed as a common assembly.

Connection device 13 can be displaced in longitudinal direction 2 during the connection of adjacent segments 8, when the transport device is moved continuously in order to convey the semi-finished web 1 continuously. Connection device 13 (the same naturally also applies to the pressure device 15), however, can also be held in a stationary manner in the longitudinal direction 2 when the conveyor device is activated in a clocked manner.

The production of another semi-finished web in which fibers 6 are oriented at an angle b relative to longitudinal direction 2 that is different from angle a is relatively easily possible by changing the angular relation between main direction 7 and longitudinal direction 2. For this it is often necessary merely to change the direction of axis 17 of supply roll 5. In a similar manner, the directions of movement 14, 16 of connection device 13 and of pressure device 15 must also be changed. However, the position and the location of separation device 11 can be left unchanged.

In a manner not shown in further detail, a coupling device can be provided, which transfers the angular alignment of supply roll 5 to connection device 13 and pressure device 15 so that connection device 13 and pressure device 15 can be moved along longitudinal edges 9, 10 of adjacent segments 8, even if the angular orientation is changed.

Semi-finished web 1 can be wound up to form a lap roll 18, in order to simplify its handling. However, it is also possible to cut off pieces with a desired size from semi-finished web 1 if a larger number of such pieces are required, for example. In this case, the winding up on lap roll 18 can be omitted and the pieces can be deposited e.g., in a magazine.

If a semi-finished web 1 with a different angular orientation of fibers 6 to longitudinal direction 2, i.e., different from angle a, is to be produced, alternatively or additionally to changing the direction of axis 17 of supply roll 5, the winding direction which is defined by the axis of lap roll 18 can also be changed.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A method for producing a semi-finished web having a longitudinal direction, a plastic matrix, and a plurality of fibers fixed in a unidirectionally oriented manner enclosing a predetermined angle (a) greater than 0° to the longitudinal direction, the method comprising:
supplying a web having a main direction, a plastic matrix, and a plurality of fibers fixed in a unidirectionally oriented manner enclosing an angle of about 0° to the main direction;
separating segments from the supplied web;
arranging the separated segments next to one another so that longitudinal edges of adjacent segments are parallel to the main direction and to one another, and enclose the predetermined angle (a) to the longitudinal direction;
connecting the adjacent segments in a region of their longitudinal edges; and
transporting the segments together by pulling the semi-finished web.

2. The method according to claim 1, further comprising laying the longitudinal edges edge to edge.

3. The method according to claim 1, wherein the segments are separated from the supplied web at the predetermined angle (a).

4. The method according to claim 3, further comprising:
feeding the supplied web at the predetermined angle (a) to the longitudinal direction; and
separating the segments along a line parallel to the longitudinal direction.

5. The method according to claim 3, further comprising separating the segments from the supplied web so that a length of the longitudinal edges corresponds to a width (B) of the semi-finished web that is crosswise to the longitudinal direction divided by the sine of the predetermined angle (a).

6. The method according to claim 1, further comprising depositing the segments on a transport device moveable in the longitudinal direction.

7. (canceled)

8. The method according to claim 1, wherein the connecting of the segments comprises connecting the segments to one another by adhesive force.

9. The method according to claim 1, wherein the connecting of the segments comprise connecting adjacent segments to one another by at least one of an adhesive strip and a strip of the material of the plastic matrix that overlaps the adjacent longitudinal edges.

10. The method according to claim 8, wherein, at least one of during and after connection, the method further comprises subjecting the segments to a pressure treatment at least in the region of their connection to one another.

11. A method for producing a semi-finished web having a longitudinal direction, a plastic matrix, and a plurality of fibers fixed in a unidirectionally oriented manner enclosing a predetermined angle (a) greater than 0° to the longitudinal direction, the method comprising:
supplying a web having a main direction, a plastic matrix, and a plurality of fibers fixed in a unidirectionally oriented manner enclosing an angle of about 0° to the main direction;
separating segments from the supplied web;
arranging the separated segments next to one another so that longitudinal edges of adjacent segments are parallel to the main direction and to one another, and enclose the predetermined angle (a) to the longitudinal direction;
connecting the adjacent segments in a region of their longitudinal edges;
wherein the supplied web has an edge strip that is free of fibers, and the edge strip of one segment separated from the supplied web overlaps an adjacent longitudinal edge of an adjacent segment.

12. The method according to claim 1, further comprising at least one of:
winding the semi-finished web form a lap roll; and
unwinding the supplied web from a supply roll.

13. A device for producing a semi-finished web having a longitudinal direction, a plastic matrix, and a plurality of fibers fixed in a unidirectionally oriented manner enclosing a predetermined angle (a) greater than 0° to the longitudinal direction, the device comprising:
a dispensing arrangement for delivering segments having a main direction, a plastic matrix, and a plurality of fibers fixed in a unidirectionally oriented manner enclosing an angle of 0° to the main direction;
an alignment device for arranging the segments next to one another so that longitudinal edges of the segments are parallel to the main direction and to one another, and enclose the predetermined angle (a) to the longitudinal direction; and
a connection device for connecting the adjacent segments in the region of their longitudinal edges.

14. The device according to claim 13, wherein the alignment device comprises a transport device and the connection device is structured and arranged to be jointly movable in the longitudinal direction with the transport device.

15. The device according to claim 13, wherein the connection device comprises a pressure device.

16. The device according to claim 13, further comprising a separating device structured and arranged to separate the segments from a web supplied in the main direction.

17. The device according to claim 16, wherein the separating device is positionable to separate the segment from the supplied web along a line in the longitudinal direction.

18. The device according to claim 13, further comprising a storage magazine into which a plurality of segments are storable and from which individual segments are movable in the main direction.

19. A method for producing a semi-finished web having a plurality of fibers that are fixed in a plastic matrix and are unidirectionally oriented at an angle greater than 0° to a longitudinal direction of the semi-finished web, the method comprising:
supplying in a main direction that is angularly offset from the longitudinal direction by more than 0° segments having a plurality of fibers that are fixed in a plastic matrix and are unidirectionally oriented generally parallel to the main direction;
moving the supplied segments in the longitudinal direction so that successively supplied segments are arranged next to one another and so that longitudinal edges of adjacent segments are parallel to the main direction and to one another; and
connecting the adjacent segments in a region of their longitudinal edges, and further comprising one of:
separating the segments from a supplied web along a line parallel to the longitudinal direction, the supplied web having a plurality of fibers that are fixed in a plastic matrix and are unidirectionally oriented generally parallel to the main direction; and
storing a plurality of segments in a storage magazine and successively feeding the segments in the main direction.

20. (canceled)

21. A method for producing a semi-finished web having a longitudinal direction, a plastic matrix, and a plurality of fibers fixed in a unidirectionally oriented manner enclosing a predetermined angle (a) greater than 0° to the longitudinal direction, the method comprising:
supplying a web having a main direction, a plastic matrix, and a plurality of fibers fixed in a unidirectionally oriented manner enclosing an angle of about 0° to the main direction;
separating segments from the supplied web;
arranging the separated segments next to one another so that longitudinal edges of adjacent segments are parallel to the main direction and to one another, and enclose the predetermined angle (a) to the longitudinal direction;
connecting the adjacent segments in a region of their longitudinal edges;
wherein the supplied web has an edge strip in which the fibers are embedded between layers of a plastic material, and the edge strip of one segment separated from the supplied web overlaps an adjacent longitudinal edge of an adjacent segment.
